(19) United States
(12) Patent Application Publication
(10) Pub. No.: US 2003/0118494 A1
(43) Pub. Date: Jun. 26, 2003

(54) Process and apparatus for conditioning of combustion flue gases with ammonia from hydrolyzed urea

(75) Inventors: Robert T. Glesmann, Towson, MD (US); Joseph J. Titus, Westminster, MD (US); Hamilton G. Walker JR., Stevensville, MD (US)

Correspondence Address: SAUL EWING LLP, CENTRE SQUARE WEST, 1500 MARKET STREET, 38TH FLOOR, PHILADELPHIA, PA, 19102-2186, US

(73) Assignee: Environmental Elements Corporation

(21) Appl. No.: 10/227,046

(22) Filed: Aug. 24, 2002

Related U.S. Application Data
(60) Provisional application No. 60/342,227, filed on Dec. 21, 2001.

(51) Int. Cl. B01D 53/56; B01J 10/00; B01J 8/00

(52) U.S. Cl. 423/235; 422/188; 422/189; 422/198

(57) ABSTRACT

An improved process and apparatus for combustion flue gas conditioning in which ammonia is produced in situ from the hydrolysis of urea and injected into a stream of combustion flue gases, wherein key components of the process and apparatus are made to function independently of other components to prevent the shut-down of the entire apparatus in the case of a single component break-down.

### RELATED APPLICATIONS

The present application claims priority from pending provisional application 60/342,227 filed Dec. 21, 2001, entitled “An Improved Method for the Production of Ammonia for Use in the Removal of Nitrogen Oxides by the Hydrolysis of Urea,” the entirety of which is incorporated by reference herein.

### FIELD OF THE INVENTION

This invention relates to a process and apparatus for conditioning combustion flue gas produced by an industrial plant by injecting gaseous ammonia derived from the hydrolysis of urea into a flue containing flue gases.

### BACKGROUND OF THE INVENTION

Industrial plants such as incinerators and electric power generation plants produce undesired quantities of nitrogen oxide and fly ash as a byproduct of combustion of fossil fuels. In order to reduce the amount of nitrogen oxide and fly ash released from the combustion process by industrial plants, ammonia gas is mixed with the flue gases. The ammonia that is used in the process to condition the flue gases is either transported to the plant as anhydrous ammonia, in an aqueous solution or directly produced on-site, which is also known as in situ ammonia production.

Ammonia transported to the plant in anhydrous aqueous form is the least desired because it is dangerous to handle and an environmental hazard. Aqueous ammonia is less dangerous, but still represents a hazard to plant workers and the local community. Accordingly, the on-site or in situ production of ammonia is most preferred because it avoids the hazards of ammonia transport and handling and can be made from solid urea, a non-toxic, safely transportable substance. The production of ammonia for use in the conditioning and reduction of nitrogen oxide and fly ash is described in U.S. Pat. 5,985,224, which is incorporated in its entirety by reference.

The ammonia is used in the conditioning process to convert nitrogen oxide into nitrogen, a naturally occurring element in the atmosphere. Reactions between ammonia and nitrogen oxides, in the presence of oxygen, result in the formation of nitrogen and water in accordance with the following formula:

ΔNH₃+2NO+2O₂⇄6H₂O+3N₂

Since aqueous ammonia solutions containing 20% or more ammonia by weight and anhydrous ammonia are classified as hazardous materials, they are strictly regulated with regard to transportation and handling. To eliminate the risk of transporting and handling ammonia, safer forms of on-site ammonia production are highly needed and in demand. One attempt to address this problem is the production of ammonia from urea at or near the point of use. Since urea is a non-toxic compound, it can be easily transported and handled with minimal risk of environmental harm or danger to personnel. In this process, urea is mixed with water and hydrolyzed to produce aqueous ammonia. The ammonia is then stripped from the aqueous solution in a gaseous form. The process of producing gaseous ammonia from an aqueous solution of ammonia by injecting steam into the solution is known as steam stripping.

Urea is easily dissolved in water forming a urea solution. Urea is known to hydrolyze and produce ammonia and carbon dioxide in solution at temperature and pressure conditions in the range of about 180° C. to 250° C. at 15 to 50 bar in accordance with the following formula:

(NH₂)₂CO+H₂O→2NH₃+CO₂.

The concentration and volume of urea solution needed to produce the necessary amount of ammonia gas for flue gas conditioning can be calculated from the estimated amount of NO production.

Because the need is great and still unmet for satisfactory on-site ammonia production, more efficient and less costly means of production are always in demand and highly sought after. Ever increasing importance is placed on high ammonia production using the least amounts of energy, equipment and process steps as possible. Because of the extreme conditions associated with ammonia production, mechanical failures can occur, which result in very costly repair and lost production. Accordingly, there is a need for an improved process and apparatus for on-site gaseous ammonia production.

### SUMMARY OF THE INVENTION

The present invention is directed to an improved process and apparatus that satisfies the need for more efficient and economical on-site production of ammonia from urea for the conditioning of combustion flue gases. The design of this invention is further enhanced in that each element of the apparatus can operate independently to facilitate maintenance of or prevent failure within the system. In addition, the present invention requires a reduced number of components as compared to a known apparatus in the field, making the present invention a more cost effective and efficient new apparatus embodying a safer and less energy demanding process.

In one embodiment of the present invention, a hopper, having a conical shape at its bottom is used to direct solid urea to a narrowed outlet. The bottom of the hopper is equipped with a vibrating mechanism to dislodge solid urea as it is directed past the outlet. From the hopper, the solid urea is transferred to a dissolver where it is mixed with water to form a solution. The dissolver has a separate inlet for water. To improve efficient use of materials and to reduce energy use, heated water is obtained from condensation or steam vapors produced elsewhere in the industrial plant or added from an independent source. The dissolver is equipped with a stirring mechanism to aid in the dissolution of the urea in the water. By means of these improvements, urea concentrations can be obtained and controlled over a range from 10% to 70% by weight.

Once the urea is dissolved in water in the dissolver, it is transferred to a solution storage tank for subsequent use. The storage tank provides dissolved urea on demand as needed by the process and ensures that ammonia production is not limited by the rate at which the urea dissolves in water. In another embodiment, the solution storage tank includes a heating element to maintain temperature as needed to prevent precipitation.

The urea solution is then pumped from the solution storage tank to a pre-heater. The pre-heater increases the temperature of the urea solution before it enters the hydrolyzer. In one embodiment of the invention, the urea solution is both pre-heated and pressurized before entering the hydrolyzer.

After pre-heating, the urea solution is transferred to at least one hydrolyzer through a urea solution inlet. Once in the hydrolyzer, additional heat is applied to the urea solution to raise its temperature above 300° F. in order to induce hydrolysis and the production of ammonia and carbon dioxide. The interior of the hydrolyzer is divided into a plurality of stages by baffles to enhance hydrolysis and stripping. In one embodiment, the apparatus includes a plurality of hydrolyzers. In another embodiment of the invention, a pressure-sensing device is mounted to the surface of at least one hydrolyzer to control the rate of ammonia production.

After the urea is hydrolyzed, steam is introduced into the hydrolyzer through a steam inlet to strip the ammonia and carbon dioxide from the solution. In one embodiment of the invention, steam is introduced through a series of inlets at the bottom of the hydrolyzer. Ammonia and carbon dioxide are then released from the hydrolyzer through a gas outlet. In another embodiment, the gas outlet is located near the top of the hydrolyzer to optimize the separation of ammonia gas from the urea solution. As the gaseous ammonia and carbon dioxide are released from the hydrolyzer, they are directed to a flue containing combustion flue gases for conditioning.

Any residual water remaining in the hydrolyzer after the stripping process is transferred to a holding tank through a residual water outlet in the hydrolyzer. Excess heat is transferred from the residual water as it leaves the hydrolyzer to the pre-heater. The residual water from the holding tank is recycled back to the dissolver for the continued production of urea solution. In one aspect of the invention, the holding tank operates at ambient air pressure.

### BRIEF DESCRIPTION OF THE DRAWINGS

These and other objects and features of this invention will be better understood from the following detailed description taken in conjunction with the drawings wherein:

FIG. 1 is an illustration of an improved process and apparatus for conditioning of combustion flue gases with ammonia from hydrolyzed urea according to one embodiment of the invention.

FIG. 2 is a graphic description correlating urea concentration and dissolution temperature.

FIG. 3 is a flow diagram of the process for conditioning of combustion flue gases with ammonia from hydrolyzed urea according to one embodiment of the invention.

### DETAILED DESCRIPTION OF THE INVENTION

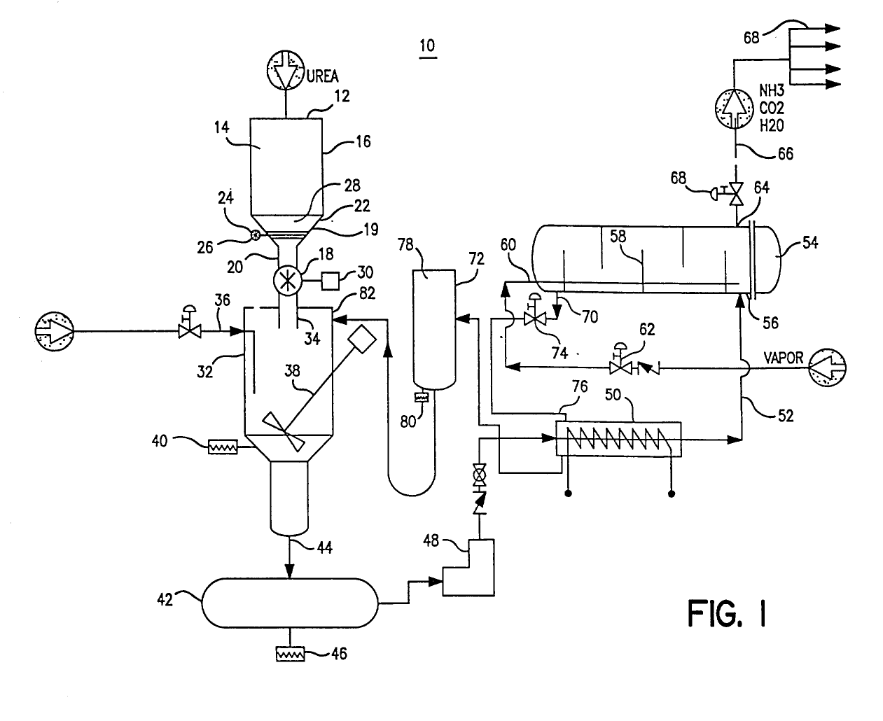

FIG. 1 depicts an illustration of an improved process and apparatus 10 for conditioning of combustion flue gases with ammonia from hydrolyzed urea according to one embodiment of the invention. Referring to FIG. 1, urea is placed into an opening 12 in the top of a hopper 14, having a main body 16 and a shaped bottom section 18. The hopper 14 has a capacity to hold enough solid urea to produce enough ammonia to condition flue gases produced by the industrial plant (not shown) for at least one day of operation. In one embodiment, urea is supplied to the hopper 14 in the form of prills or granules. Urea is commercially available as either prills or granules as well as in other forms. Prills are spherical formations of urea typically having diameters between about 0.1 mm to about 1 mm. Granules are larger spherical formations of urea, typically 1 to 4 mm in diameter, and are harder and more resistant to moisture.

In one embodiment of the invention, the hopper 14 has a bottom section 18 with a conical shape 19. The conical shape 19 of the bottom section 18 of the hopper 14 helps to direct the solid urea to the hopper outlet 20 located at the bottom of the hopper 14.

Because of the hygroscopic nature of urea, the prills or granules tend to absorb water from the air, which has the effect of cementing the individual urea granules or prills into a single large mass and leads to clogging of the output from the hopper. In one aspect, the hopper 14 is equipped with a series of porous plates 22 that transverse the hopper's interior and through which dry air is injected.

Air dried with chemical desiccants is passed through plates 22 near the bottom 18 of the hopper 14. It is directed through the urea as the urea passes over the porous plates 22 to further prevent any sticking. The injection of the dried air drives out excess moisture present in the urea and prevents the influx of ambient air into the hopper 14. Once the urea has been dried it is released from the hopper by a slide valve 26.

In one aspect of the invention, the bottom 18 of the hopper 14 is also equipped with a vibrating mechanism that dislodges any urea that may stick in hopper 14. In one embodiment, the conically shaped bottom section 18 of the hopper 14 is flexibly connected to the main body 16 of the hopper 14. The conically shaped bottom section 18 is vibrated periodically by a large attached vibrating electric motor. In another embodiment, the conically shaped bottom section 18 is equipped with strike plates 28 for the manual dislodging of the urea.

Solid urea passes from the hopper 14 to a dissolver 32 through a urea inlet 34 where it is mixed with water to form a urea solution. The dissolver 32 has water inlet for water 36. Water for making the urea solution may also be obtained from an external source. The dissolver 32 is also equipped with a stirring mechanism 38 that mixes the solution to speed the dissolution of the solid urea in the water.

The urea solution made in the dissolver 32 is typically between about 10% to 70% urea by weight. In one embodiment, the composition is between about 35% to about 50% urea by weight. The dissolver 32 includes a heating element 40. The temperature of the water in the dissolver 32 is between 80° F. to about 200° F., but it is preferably between about 125° F. to about 150° F.

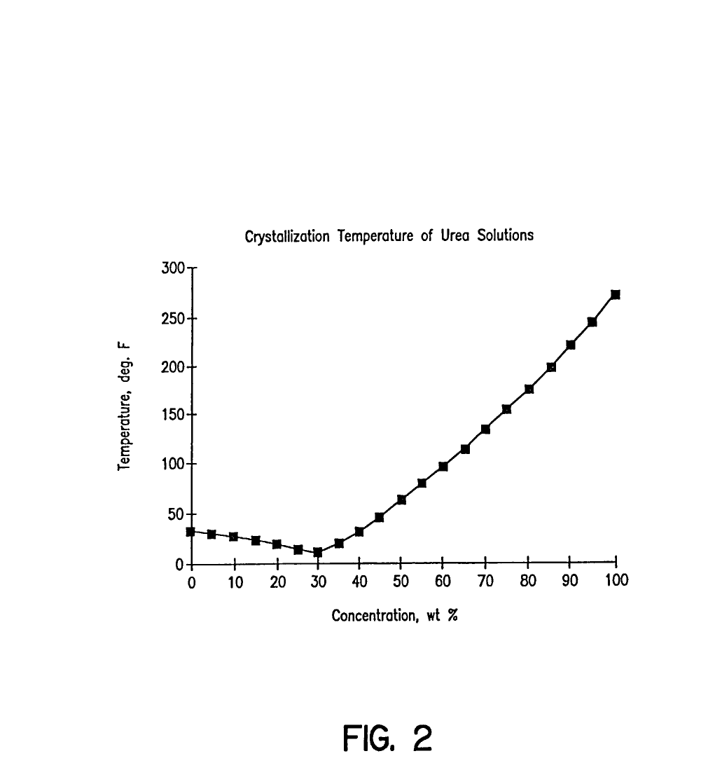

FIG. 2, illustrates the crystallization temperatures of urea solutions. Urea that has been dissolved in water at a concentration of about 70% by weight will remain dissolved if the water temperature is maintained at about 134° F. at ambient pressure. Exact concentrations and temperature may vary from those presented in FIG. 2 due to variations in pressure and impurities.

Once the urea solution is made in the dissolver 32, it is transferred to a solution storage tank 42 through an outlet 44. The inclusion of the solution storage tank 42 in the apparatus of the invention is advantageous because it allows a surplus of urea solution to be available for ammonia production. Therefore, ammonia can be produced independent of urea solution production. In addition, a mechanical break-down in the dissolver 32 will not cause a complete shut-down of the system.

In one aspect of the invention, the solution storage tank 42 includes a heating element 46 that is capable of maintaining the temperature of the urea solution at a temperature sufficient to prevent urea from precipitating. The temperature of the urea solution in the solution storage tank 42 is maintained between about 50° F. to about 90° F. In another embodiment of the invention, the solution in the storage tank can be maintained at above 100° F.

The solution storage tank 42 allows urea solution to be available for hydrolysis regardless of any mechanical failures that may occur in association with the dissolver 32. It is this stored supply of urea solution that can be used for the production of ammonia even if the hopper 14 or dissolver 32 become clogged or break down. By maintaining the temperature of the solution, the heating element prevents any dissolved urea from precipitating out of solution and therefore prevents any solid urea formation in the solution storage tank 42.

The urea solution in the solution storage tank 42 is pumped by a mechanical pump 48 to a pre-heater 50. The pump pressurizes the urea solution and the pre-heater elevates the temperature of the urea solution prior to hydrolysis.

After pre-heating, the urea solution is transferred to a feed line 52 to the hydrolyzer 54 through a urea solution inlet 56 in the hydrolyzer. The interior of the hydrolyzer 54 contains a plurality of baffles 58 that create a series of interior compartments that are in fluid contact with one another. The interior compartments created by the baffles 58 provide local environments for solution in the hydrolyzer 54. The changing concentrations of the solution in each compartment or local environment allow more complete reaction and higher efficiency compared with a solution in a non-compartmentalized hydrolyzer. Because the efficiency of hydrolysis and stripping are dependent on the temperature and concentration of the solution, the baffles within the interior of the hydrolyzer 54 serve to optimize both processes. The spacing, size, and number of baffles 58 within the hydrolyzer 54 can be varied.

Once the urea solution has been transferred to the hydrolyzer 54, the urea solution is subject to sufficient heat to hydrolysis the urea and create a hydrolyzed solution comprising ammonia and carbon dioxide in water. In one embodiment, the urea solution is heated to about 195° C. The temperature, pressure and time for hydrolysis can be varied to optimize ammonia production rates. In another embodiment of the invention, the rate of production of ammonia and carbon dioxide from hydrolysis is controlled by a pressure sensing device that is flush mounted to the surface of hydrolyzer 54. In yet another embodiment of the invention, more than one hydrolyzer is connected to a common urea solution inlet 56. Each hydrolyzer can be used alone or simultaneously with at least one other. Multiple hydrolyzers reduce the chances of a complete shut-down of the apparatus because of mechanical failure, allowing one hydrolyzer to be serviced while the others remain in operation.

After a sufficient time has elapsed for hydrolysis, steam is injected into the hydrolyzer 54 through at least one steam inlet 60 to strip the ammonia and carbon dioxide from the hydrolyzed solution. The steam inlet contains a pressure valve 62 to maintain the pressure of the contents of the hydrolyzer 54. Steam for stripping may be obtained from steam produced by other industrial processes occurring at the plant or it can be made from water from an independent source.

The ammonia and carbon dioxide are stripped from the hydrolyzed solution in gaseous form. Ammonia and carbon dioxide gas are then released from the hydrolyzer 54 through a gas outlet 64 and sent to an output line 66. In one e aspect of the invention, the gas outlet 64 is located on the hydrolyzer to optimize the separation of ammonia gas from the hydrolyzed solution. The output line includes a pressure valve 68 necessary to maintain the pressure of the contents of the hydrolyzer 54. Gaseous ammonia and carbon dioxide are then directed to a flue where they enter a stream of combustion flue gases. In one embodiment of the invention, multiple hydrolyzers are connected to the same output line 66.

In another embodiment of the invention, the output line 66 can feed ammonia and carbon dioxide gas to multiple gas ducts 68. These ducts 68 allow the ammonia that is produced from the hydrolysis of the urea to be distributed to several different flues or different areas of a single flue. The flow of gas to each gas duct 68 can be independently controlled.

After stripping, residual water remains in the hydrolyzer 54. The residual water is transferred from the hydrolyzer 54 through a residual water outlet 70 in the hydrolyzer 54 to a holding tank 72. The residual water is passed from the hydrolyzer 54 to the holding tank 72 through a pressure valve 74 that maintains the pressure of the contents of the hydrolyzer 54 during hydrolysis.

The residual water leaving the hydrolyzer 54 is well above the temperature necessary for the dissolution of urea. Excessive heat from the residual water can be transferred from the residual water as it leaves the hydrolyzer 54 to the pre-heater 50, reducing the energy requirement of the pre-heater 50 while allowing the water in the holding tank 72 to remain warm enough to dissolve urea at the proper concentrations when sent to the dissolver 32. In one aspect of the invention, water is sent through a line 76 that contacts the pre-heater 50 and loops back to the holding tank 72, allowing excess heat from the water to transfer to the pre-heater 50.

In one aspect of the invention, the holding tank 72 is open to ambient air pressure. The holding tank 72 can be covered to prevent excessive evaporation of the residual water in the holding tank 72 and can release steam through an open vent 78 if the pressure becomes too great. In another embodiment, the holding tank 72 includes a heating element 80 to maintain the temperature of the residual water at a temperature above about 80° F. Residual water in the holding tank is directed back to the dissolver 32 through a residual water inlet 82 in the dissolver 32 for the dissolution of urea.

In U.S. Pat. No. 5,985,224 (Lagana), a separator was included in the apparatus for further separation of ammonia remaining in the residual water. The residual water in the separator was heated under pressure to further separate any ammonia remaining in the residual water from the residual water. Gases produced from the heating of the residual water in the separator were sent to the flue containing flue gases. The present invention eliminates the need for the separator because the stripping of the hydrolyzed solution eliminates essentially all of the ammonia. Therefore, the separator has been made unnecessary in the new apparatus.

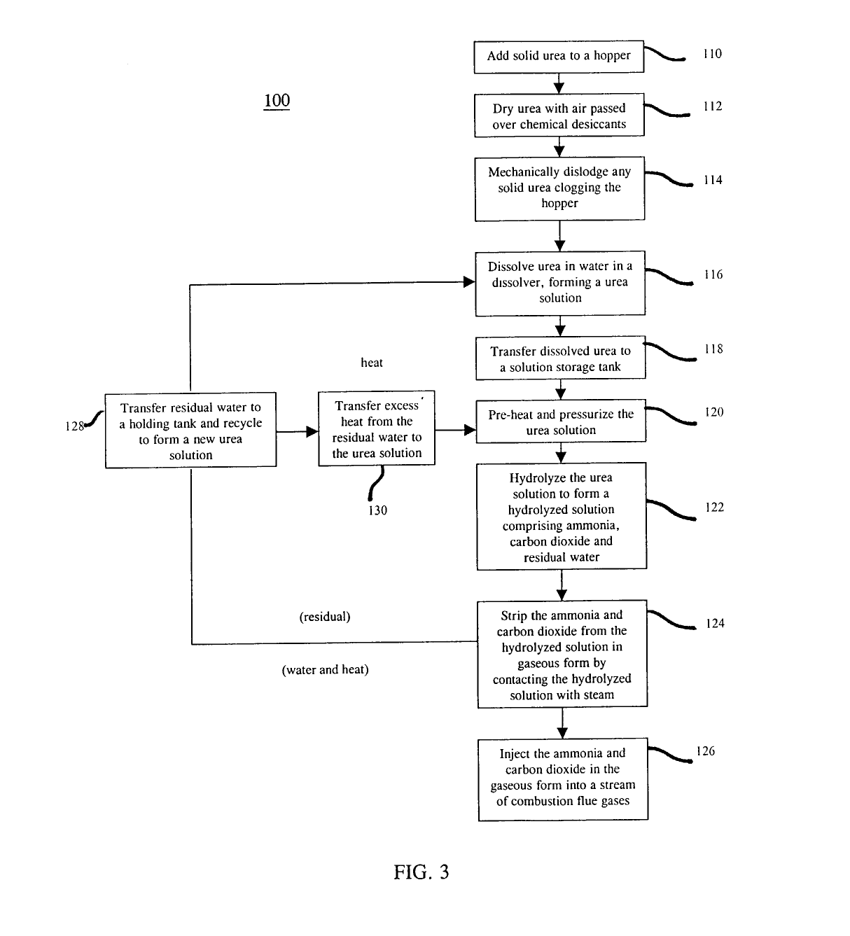

FIG. 3 illustrates one embodiment of the process 100 of conditioning combustion flue gases with ammonia from hydrolyzed urea. In this embodiment, solid urea is added to a hopper 110 and dried with air that has been dried over chemical desiccants 112. Any solid urea that may clog the hopper is dislodged by mechanically vibrating or striking the hopper 114. The dried urea is then fed through a roll-type feeder to a dissolver where it is mixed with water to form a urea solution 116. Dissolution of the urea in water may be quickened with mechanical stirring. The urea solution is then stored in a solution storage tank until it is needed for the production of ammonia 118. The temperature of the urea solution is maintained to prevent precipitation. The temperature of the solution depends on the concentration of the urea, but is typically between about 50° F. to about 90° F.

When the urea solution is needed for ammonia production, it is pre-heated and pressurized 120. The pre-heated and pressurized urea solution is then hydrolyzed to form a hydrolyzed solution including ammonia, carbon dioxide and residual water 122. The ammonia and carbon dioxide in the hydrolyzed solution are then stripped from the solution by steam injected into the hydrolyzed solution 124. Stripping causes the ammonia and carbon dioxide to be released from the solution in gaseous form. The gaseous ammonia and carbon dioxide are then injected into an industrial flue containing flue gases 126.

After the ammonia and carbon dioxide are stripped from the hydrolyzed solution, residual water is used to pre-heat additional urea solution prior to hydrolysis 130. The temperature of the residual water in the holding tank can be maintained between about 80° F. to about 200° F. The residual water is recycled to produce more urea solution in the dissolver.

These and other advantages of the present invention will be apparent to those skilled in the art from the foregoing specification. Accordingly, it will be recognized by those skilled in the art that changes or modifications may be made to the abovedescribed embodiments without departing from the broad inventive concepts of the invention. It should therefore be understood that this invention is not limited to the particular embodiments described herein, but is intended to include all changes and modifications that are within the scope and spirit of the invention.

What is claimed:

1. A process for conditioning of combustion flue gases with ammonia from hydrolyzed urea comprising the steps of:
a) adding solid urea to a hopper;
b) transferring the urea from the hopper to a dissolver;
c) dissolving the urea in water in the dissolver, forming a urea solution;
d) transferring the urea solution to a solution storage tank;
e) pumping the urea solution from the solution storage tank to a pre-heater;
f) pre-heating said urea solution;
g) transferring the pre-heated urea solution to at least one hydrolyzer;
h) hydrolyzing the urea in the urea solution, forming a hydrolyzed solution comprising ammonia, carbon dioxide and residual water;
i) stripping said ammonia and carbon dioxide from said hydrolyzed solution by contacting said hydrolyzed solution with steam;
j) injecting said ammonia and carbon dioxide in a gaseous form through a gas outlet in at least one hydrolyzer into said stream of said combustion flue gas;
k) transferring the residual water from at least one hydrolyzer through a heat exchanger to a holding tank; and
l) recycling residual water from the holding tank to the dissolver.

2. The process according to claim 1, further comprising drying the solid urea with air as it passes from the hopper to the dissolver.

3. The process according to claim 1, further comprising vibrating the bottom of the hopper to dislodge any solid urea.

4. The process according to claim 1, further comprising controlling the temperature of the urea solution in the solution storage tank.

5. The process according to claim 4, wherein the temperature of the urea solution is maintained between about 50° F. to about 90° F.

6. The process according to claim 1, wherein the interior of at least one hydrolyzer includes a series of baffles.

7. The process according to claim 1, further comprising optimizing the separation of ammonia gas from the hydrolyzed solution by adjusting the location of a gas outlet in the hydrolyzer.

8. The process according to claim 1, further comprising controlling ammonia production with a flush mounted pressure detector on at least one hydrolyzer.

9. The process according to 1, further comprising transferring excess heat from the residual water leaving at least one hydrolyzer to the pre-heater.

10. The process according to 1, further comprising controlling the temperature of the residual water in the holding tank.

11. The improved process for combustion flue gas conditioning of claim 10, wherein the residual water in the holding tank is maintained at a temperature between about 80° F. to about 200° F.

12. An apparatus for conditioning of combustion flue gases with ammonia from hydrolyzed urea comprising:
a) a hopper including an inlet, a main body with a shaped bottom section, and an outlet;
b) a dissolver including a urea inlet, a water inlet, a residual water inlet, and an outlet;
c) a solution storage tank including an inlet and an outlet;
d) a line with a pump connecting the solution storage tank to a pre-heater
e) a pre-heater;
f) at least one hydrolyzer including a urea solution inlet, a steam inlet, at least one gas outlet, and a residual water outlet; and
g) a holding tank including an inlet and an outlet.

13. The apparatus of claim 12, wherein the shaped bottom section of the hopper is conical in shape.

14. The apparatus of claim 12, wherein the shaped bottom section of the hopper is flexibly attached to the main body of the hopper.

15. The apparatus of claim 14, further comprising a vibrating mechanism attached to the bottom section of the hopper.

16. The apparatus of claim 12, wherein the hopper has an air inlet through which dried air can flow into the hopper.

17. The apparatus of claim 12, wherein the solution storage tank has a heating element.

18. The apparatus of claim 17, wherein the heating element is capable of maintaining the temperature of the contents of the solution storage tank between about 50° F. to about 90° F.

19. The apparatus of claim 17, wherein the heating element is capable of maintaining the temperature of the contents of the solution storage tank at a temperature of at least 100° F.

20. The apparatus of claim 12, wherein at least one hydrolyzer has an interior including a series of baffles.

21. The apparatus of claim 12, wherein at least one hydrolyzer has a body with a welded body construction.

22. The apparatus of claim 12, wherein at least one hydrolyzer has a flush mounted pressure detector.

23. The apparatus of claim 12, wherein at least one hydrolyzer has multiple gas outlets.

24. 25. The apparatus of claim 12, wherein the holding tank includes a heating element.

26. The apparatus of claim 25, wherein the heating element can maintain the temperature of the contents of the holding tank between about 80° F. to about 200° F.

27. The apparatus of claim 12, wherein the holding tank is covered.

28. The apparatus of claim 12, wherein the holding tank is exposed to ambient air pressure.

29. The apparatus of claim 12, wherein the holding tank has a vent through which excess steam can escape.

30. In a process for conditioning combustion flue gas by ammonia gas produced in situ where the process includes dissolving urea in water, forming a urea solution, pre-heating urea solution in a pre-heater, and then heating and pressuring the solution in a hydrolyzer, where the urea solution is hydrolyzed forming carbon dioxide and ammonia in solution, stripping the ammonia and carbon dioxide from the solution with steam introduced into the hydrolyzer to form gaseous ammonia and carbon dioxide and leaving residual water in the hydrolyzer, injecting the ammonia and carbon dioxide into a stream of combustion flue gases, and sending the residual water from the hydrolyzer to a separator and recycling the residual water, the improvement comprising:
a) storing a surplus urea solution in a solution storage tank;
b) connecting more than one hydrolyzers to a common output line, thereby eliminating the need for a separator;
c) directing the residual water to a holding tank; and
d) recycling the residual water from the holding tank to the dissolver.

31. The process according to claim 30, further comprising controlling the temperature of urea solution in the solution storage tank.

32. The process according to claim 30, further comprising controlling the rate of production of ammonia in at least one hydrolyzer with a pressure sensing device.

33. The process according to claim 30, further comprising transferring excess energy from the residual water to the pre-heater.

34. The process according to claim 30, further comprising maintaining the temperature of the residual water in the holding tank.
